(19) United States
(12) Patent Application Publication
(10) Pub. No.: US 2015/0336054 A1
(43) Pub. Date: Nov. 26, 2015

(54) PROCESS AND APPARATUS FOR PRODUCING OXYGEN AND NITROGEN USING ION TRANSPORT MEMBRANES

(71) Applicant: Air Products and Chemicals, Inc., Allentown, PA (US)

(72) Inventors: William S. Rollins, New Boston, NH (US); VanEric Edward Stein, Allentown, PA (US)

(21) Appl. No.: 14/358,452

(22) PCT Filed: Feb. 27, 2014
(86) PCT No.: PCT/US2014/018848

§ 371 Date: May 15, 2014

Related U.S. Application Data
(60) Provisional application No. 61/770,761, filed on Feb. 28, 2013.

(51) Int. Cl. B01D 63/00; C01B 21/04; C01B 13/02; B01D 53/22

(52) U.S. Cl. CPC B01D 63/00; B01D 53/225; C01B 21/0438; C01B 13/0251; B01D 2053/221; B01D 2311/10

(57) ABSTRACT

Process and apparatus for producing an oxygen product gas and a nitrogen product gas using ion transport membrane assemblies. The apparatus comprises at least two ion transport membrane assemblies and a turboexpander downstream of one of the ion transport membrane assemblies. In the process, an oxygen- and nitrogen-containing gas is introduced into a first of the ion transport membrane assemblies to produce oxygen-depleted gas and oxygen product gas. The oxygen-depleted gas is divided, with a first portion being expanded in the turboexpander and a second portion introduced into a second of the ion transport membrane assemblies. A nitrogen-rich product gas and additional oxygen product gas are withdrawn from the second ion transport membrane assembly.

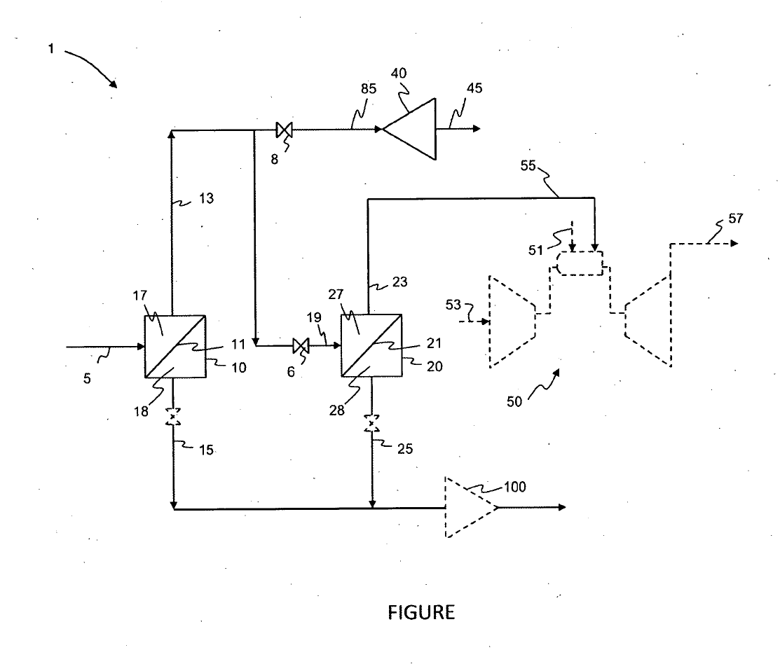

### CROSS-REFERENCE TO RELATED APPLICATIONS

This application claims priority to provisional patent application U.S. Ser. No. 61/770,761, titled “Process and Apparatus for Producing Oxygen and Nitrogen using Ion Transport Membranes”, filed Feb. 28, 2013, incorporated herein by reference.

### STATEMENT REGARDING FEDERALLY SPONSORED RESEARCH OR DEVELOPMENT

This invention was made with government support under Cooperative Agreement No. DE-FC26-98FT40343 between Air Products and Chemicals, Inc. and the U.S. Department of Energy. The United States Government has certain rights in this invention.

### BACKGROUND

Air can be separated at high temperatures to produce high-purity oxygen by the use of mixed-conducting multicomponent metallic oxide membranes. These membranes operate by the selective transport of oxygen ions and may be described as ion transport membranes. The mixed-conducting multicomponent metallic oxide material used in ion transport membranes conducts both oxygen ions and electrons, wherein the transported oxygen ions recombine at the product side of the membrane to form oxygen gas.

The feed gas to ion transport membrane separation systems is an oxygen- and nitrogen-containing gas (for example, air) that is compressed and heated prior to the membrane system to pressures in the general range of 0.7 MPa (100 psia) to 4.1 MPa (600 psia) and temperatures in the general range of 750° C. to 950° C. A portion of the feed gas is transported through the membrane and is recovered as hot, high-purity oxygen product. The remaining portion of the feed gas is partially depleted of oxygen and still contains a significant amount of heat and pressure energy.

The hot, pressurized, oxygen-depleted gas may be used in a number of process applications. For example, the significant amount of heat and pressure energy in the gas may be recovered in an expansion turbine to improve the overall economics of oxygen generation. The ion transport membrane system may be integrated with a gas turbine (combustion turbine) system in a variety of process arrangements to optimize the operation of both systems.

Ion transport membrane (ITM) systems designed to produce tonnage quantities of oxygen use mixed-conducting multicomponent metallic oxide membrane materials that transport oxygen based on a difference in the partial pressure of oxygen between the feed and product sides. As a result, the maximum theoretical oxygen recovery occurs when the partial pressure of oxygen in the feed equals the partial pressure of oxygen in the product, and infinite membrane area is required to reach this condition. For example, with pure oxygen product at 103 kPa (15 psia) (pO₂=103 kPa (15 psia)) and an oxygen- and nitrogen-containing gas feed at 2068 kPa (300 psia) with 20 mole % oxygen (pO₂=413 kPa (60 psia)), maximum theoretical oxygen recovery occurs when only 5 mole % oxygen remains in the oxygen-depleted gas stream. As a practical economic matter, the oxygen-depleted stream would likely contain several more mole % oxygen. Thus, it is difficult to design an ITM system to produce a high-pressure nitrogen product with low oxygen content, and the last few % of oxygen removal from the oxygen-depleted stream can require a very large membrane surface area.

A synergistic application for ITM systems involves an integrated gasification combined cycle (IGCC) plant, which typically requires large quantities of oxygen for gasification and nitrogen-rich gas for use as a diluent to control NOx formation in a gas turbine. A typical maximum oxygen content for this diluent nitrogen stream is about 2 mole %, although concentrations up to 16 mole % may be used in some applications with alternative combustion control strategies, for example for NOx control. One way to achieve an oxygen level of less than about 2 mole % is to simply stretch the bounds of total pressure (i.e., increase the ITM feed gas pressure and/or decrease the oxygen product pressure) until the oxygen-depleted stream reaches the desired oxygen content with a reasonable membrane area requirement. This strategy leads to significant increases in capital and operating costs for major auxiliary equipment such as, for example, air and/or oxygen compressors requiring higher pressure ratios, larger compressor drive motors, higher pressure ratings for high-temperature heat exchangers, or lower pressure drop allowances for oxygen cooling equipment and piping. Another alternative to achieve an oxygen level of less than about 2 mole % is discussed in EP 0 916 385 to Keskar et al., where a retentate stream from an ion transport separator is sent to a reactively purged ion transport separator. The reactively purged ion transport separator functions as a deoxo unit which separates the residual oxygen by ion transport to the anode side where it reacts with a fuel purge stream to produce a very low partial oxygen pressure and thereby enhance oxygen removal.

There is a need in the art for improved ion transport membrane processes and systems for the co-production of a high-purity oxygen product and a nitrogen-rich product. There also is a need to maximize the overall efficiency of these processes by recovering energy from any of the hot pressurized effluent gas streams from the ion transport membrane system. These needs are addressed by the embodiments of the invention described below and defined by the claims that follow.

### BRIEF SUMMARY

The present invention relates to an apparatus and a process for producing oxygen and nitrogen using ion transport membranes.

There are several aspects of the apparatus and process as outlined below. The reference numbers and expressions set in parentheses are referring to an example embodiment explained further below with reference to the FIGURES. The reference numbers and expressions are, however, only illustrative and do not limit the aspect to any specific component or feature of the example embodiment. The aspects can be formulated as claims in which the reference numbers and expressions set in parentheses are omitted or replaced by others as appropriate.

Aspect 1. An apparatus for producing co-product oxygen and nitrogen streams, the apparatus comprising:
a first ion transport membrane assembly (10) having an inlet for introducing an oxygen- and nitrogen-containing gas (5) comprising oxygen and nitrogen into the first ion transport membrane assembly (10), a first outlet for withdrawing an oxygen-depleted gas (13) from the first ion transport membrane assembly (10), and a second outlet for withdrawing an oxygen product gas (15) from the first ion transport membrane assembly (10);
a turboexpander (40) having an inlet for introducing a turboexpander feed (85) into the turboexpander (40), the turboexpander feed formed from a first portion of the oxygen-depleted gas (13), and an outlet for withdrawing an exhaust gas (45) from the turboexpander (40), the inlet of the turboexpander (40) in downstream fluid flow communication with the first outlet of the first ion transport membrane assembly (10); and
a second ion transport membrane assembly (20) having an inlet for introducing a feed (19) into the second ion transport membrane assembly (20), the feed formed from a second portion of the oxygen-depleted gas (13), a first outlet for withdrawing a nitrogen product gas (23), and a second outlet for withdrawing an oxygen product gas (25) from the second ion transport membrane assembly (20), the inlet of the second ion transport membrane assembly (20) in downstream fluid flow communication with the first outlet of the first ion transport membrane assembly (10);
wherein the second ion transport membrane assembly (20) is not in downstream fluid flow communication with the turboexpander (40), and
wherein the turboexpander (40) is not in downstream fluid flow communication with the second ion transport membrane assembly (20).

Aspect 2. The apparatus of aspect 1 further comprising:
an oxygen compressor (100) having an inlet and an outlet, the inlet of the oxygen compressor (100) in downstream fluid flow communication with at least one of the second outlet of the first ion transport membrane assembly (10) for receiving the oxygen product gas (15) from the first ion transport membrane assembly (10), and the second outlet of the second ion transport membrane assembly (20) for receiving the oxygen product gas (25) from the second ion transport membrane assembly (20).

Aspect 3. The apparatus of aspect 1 further comprising:
an oxygen compressor (100) having an inlet and an outlet, the inlet of the oxygen compressor (100) in downstream fluid flow communication with the second outlet of the first ion transport membrane assembly (10) for receiving the oxygen product gas (15) from the first ion transport membrane assembly (10), and the second outlet of the second ion transport membrane assembly (20) for receiving the oxygen product gas (25) from the second ion transport membrane assembly (20).

Aspect 4. The apparatus of any one of aspects 1 to 3 further comprising at least one flow control device (6, 8) adapted to control the flow rate of the turboexpander feed (85) to the turboexpander (40) and/or the flow rate of the feed (19) to the second ion transport membrane assembly (20).

Aspect 5. The apparatus of any one of aspects 1 to 4 further comprising a gas turbine combustion engine (50) with a combustor having a combustion zone and a dilution zone downstream of the combustion zone, the gas turbine combustion engine (50) having an inlet for introducing a low-oxygen content dilution gas (55), the low-oxygen content dilution gas (55) formed from the nitrogen product gas (23), an inlet for introducing a fuel (51), and an inlet for introducing an oxygen-containing gas (53), the combustion zone and/or the dilution zone in downstream fluid flow communication with the first outlet of the second ion transport membrane assembly (20) for receiving the low-oxygen content dilution gas (55) formed from the nitrogen product gas (23).

Aspect 6. A process for producing co-product oxygen and nitrogen streams, the process comprising:
providing the apparatus of any one of aspects 1 to 5;
introducing the oxygen- and nitrogen-containing gas (5) comprising oxygen and nitrogen into the inlet of the first ion transport membrane assembly (10), the oxygen- and nitrogen-containing gas (5) having a temperature ranging from 750° C. to 950° C. and a pressure ranging from 689 kPa to 4136 kPa, withdrawing the oxygen-depleted gas (13) from the first outlet of the first ion transport membrane assembly (10), and withdrawing the first oxygen product gas (15) from the second outlet of the first ion transport membrane assembly (10);
dividing the oxygen-depleted gas (13) into the first portion and the second portion;
expanding the turboexpander feed (85) formed from the first portion of the oxygen-depleted gas (13) in the turboexpander (40) to recover shaft work or electrical energy and to provide the exhaust gas (45) from the turboexpander (40); and
introducing the feed (19) formed from the second portion of the oxygen-depleted gas (13) into the inlet of the second ion transport membrane assembly (20), withdrawing the nitrogen product gas (23) having a pressure ranging from 689 kPa to 4136 kPa from the second ion transport membrane assembly (20), and withdrawing the oxygen product gas (25) from the second outlet of the second ion transport membrane assembly (20).

Aspect 7. A process for producing co-product oxygen and nitrogen streams using the apparatus of any one of aspects 1 to 5, the process comprising:
introducing the oxygen- and nitrogen-containing gas (5) comprising oxygen and nitrogen into the inlet of the first ion transport membrane assembly (10), the oxygen- and nitrogen-containing gas having a temperature ranging from 750° C. to 950° C. and a pressure ranging from 689 kPa to 4136 kPa, withdrawing the oxygen-depleted gas from the first outlet of the first ion transport membrane assembly, and withdrawing the oxygen product gas (15) from the second outlet of the first ion transport membrane assembly (10);
dividing the oxygen-depleted gas (13) into the first portion and the second portion;
expanding the turboexpander feed formed from the first portion of the oxygen-depleted gas in the turboexpander to recover shaft work or electrical energy and to provide the exhaust gas from the turboexpander; and
introducing the feed formed from the second portion of the oxygen-depleted gas into the inlet of the second ion transport membrane assembly, withdrawing the nitrogen product gas having a pressure ranging from 689 kPa to 4136 kPa from the second ion transport membrane assembly, and withdrawing the oxygen product gas (25) from the second outlet of the second ion transport membrane assembly.

Aspect 8. The process of aspect 6 or aspect 7 further comprising:
selecting an operating pressure range for the oxygen- and nitrogen-containing gas (5);
selecting an operating pressure range for the oxygen product gas (15) from the first ion transport membrane assembly (10);
selecting an operating pressure range for the oxygen product gas (25) from the second ion transport membrane assembly (20);
selecting an operating pressure range for the feed (19) to the second ion transport membrane assembly (20);
selecting an operating temperature range for the first ion transport membrane assembly (10); and
selecting an operating temperature range for the second ion transport membrane assembly (20);
wherein the first ion transport membrane assembly (10) comprises a first number of membrane units and the second ion transport membrane assembly (20) comprises a second number of membrane units and wherein the first number of membrane units and the second number of membrane units are each provided in a number sufficient to provide the nitrogen product gas (23) with an oxygen concentration less than about 2 mole % oxygen for the selected operating pressure range for the oxygen- and nitrogen-containing gas (5), the selected operating pressure range for the oxygen product gas from the first ion transport membrane assembly (10), the selected operating pressure range for the oxygen product gas from the second ion transport membrane assembly (20), the selected operating pressure range for the feed (19) to the second ion transport membrane assembly (20), the selected operating temperature range for the first ion transport membrane assembly (10), and the operating temperature range for the second ion transport membrane assembly (20).

Aspect 9. The process of any one of aspects 6 to 8 wherein the feed (19) to the second ion transport membrane assembly (20) has a molar flow rate, and wherein the first ion transport membrane assembly (10) comprises a first number of membrane units and the second ion transport membrane assembly (20) comprises a second number of membrane units wherein the first number of membrane units and the second number of membrane units are sufficient to provide the nitrogen product gas (23) with an oxygen concentration less than about 2 mole % oxygen, the process further comprising:
regulating the pressure of the oxygen- and nitrogen-containing gas (5);
regulating a pressure of the oxygen product gas (15) from the first ion transport membrane assembly (10);
regulating a pressure of the second oxygen product gas (25) from the second ion transport membrane assembly (20);
regulating a pressure of the feed (19) to the second ion transport membrane assembly (20);
regulating a temperature in the first ion transport membrane assembly (10); and regulating a temperature in the second ion transport membrane assembly (20);

wherein the pressure of the oxygen- and nitrogen-containing gas (5), the pressure of the oxygen product gas (15) from the first ion transport membrane assembly (10), the pressure of the oxygen product gas (25) from the second ion transport membrane assembly (20), the pressure of the feed (19) to the second ion transport membrane assembly (20), the temperature in the first ion transport membrane assembly (10), and the temperature in the second ion transport membrane assembly (20) are regulated to provide the nitrogen product gas (23) with an oxygen concentration less than about 2 mole % oxygen for the molar flow rate of the feed (19) to the second ion transport membrane assembly (20).

Aspect 10. The process of any one of aspects 6 to 9 further comprising introducing a low-oxygen content dilution gas (55) into a combustor of a gas turbine (50), the low-oxygen content dilution gas (55) formed from the nitrogen product gas (23).

Aspect 11. The process of aspect 11 wherein the low-oxygen content dilution gas (55) is formed from the nitrogen product gas (23) without compressing the nitrogen product gas (23).

Aspect 12. The process of any one of aspects 6 to 11 wherein the pressure of the oxygen product gas (25) from the first ion transport membrane assembly (10) is regulated to within 20 kPa of the pressure of the oxygen product gas from the second ion transport membrane assembly (20).

### BRIEF DESCRIPTION OF THE DRAWINGS

The sole FIGURE is a schematic flow diagram of an embodiment of the present invention.

### DETAILED DESCRIPTION

The present invention relates to a process and apparatus for producing an oxygen product and a nitrogen product. The oxygen product may be used, for example, in a gasifier and the nitrogen product may be used, for example, for NOx control in a gas turbine.

The following definitions apply to terms used in the description of the embodiments of the invention presented herein.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity. The term “and/or” placed between the last two entities of a list of 3 or more entities means at least one of the entities in the list.

The phrase “at least a portion” means “a portion or all.” The at least a portion of a stream may have the same composition as the stream from which it is derived. The at least a portion of a stream may include specific components of the stream from which it is derived.

As used herein a “divided portion” of a stream is a portion having the same chemical composition as the stream from which it was taken.

As used herein, “plurality” means two or more.

As used herein, “in fluid flow communication” means operatively connected by one or more conduits, manifolds, valves and the like, for transfer of fluid. A conduit is any pipe, tube, passageway or the like, through which a fluid may be conveyed. An intermediate device, such as a pump, compressor, or vessel, may be present between a first device in fluid flow communication with a second device unless explicitly stated otherwise.

“Downstream” and “upstream” refer to the intended flow direction of the process fluid transferred. If the intended flow direction of the process fluid is from the first device to the second device, the second device is in downstream fluid flow communication with the first device.

An ion transport membrane layer is an active layer of ceramic membrane material comprising mixed metal oxides capable of transporting or permeating oxygen ions at elevated temperatures. The ion transport membrane layer also may transport electrons as well as oxygen ions, and this type of ion transport membrane layer typically is described as a mixed conductor membrane layer. The ion transport membrane layer also may include one or more elemental metals thereby forming a composite membrane.

The membrane layer, being very thin, is typically supported by a porous layer support structure and/or a ribbed support structure. The support structure is generally made of the same material (i.e. it has the same chemical composition), so as to avoid thermal expansion mismatch. However, the support structure might comprise a different chemical composition than the membrane layer.

A membrane unit, also called a membrane structure, comprises a feed zone, an oxygen product zone, and a membrane layer disposed between the feed zone and the oxygen product zone. An oxygen- and nitrogen-containing gas is passed to the feed zone and contacts one side of the membrane layer, oxygen is transported through the membrane layer, and an oxygen-depleted gas is withdrawn from the feed zone. An oxygen gas product, which may contain at least 99.0 vol % oxygen, is withdrawn from the oxygen product zone of the membrane unit. The membrane unit may have any configuration known in the art. When the membrane unit has a planar configuration, it is typically called a “wafer.”

A membrane module, sometimes called a “membrane stack,” comprises a plurality of membrane units. Membrane modules may have any configuration known in the art.

An “ion transport membrane assembly,” also called an “ion transport membrane system,” comprises one or more membrane modules, a pressure vessel containing the one or more membrane modules, and any additional components necessary to introduce one or more feed streams and to withdraw two or more effluent streams formed from the one or more feed streams. The additional components may comprise flow containment duct(s), insulation, manifolds, etc. as is known in the art. When two or more membrane modules are used, the two or more membrane modules in an ion transport membrane assembly may be arranged in parallel and/or in series.

Exemplary ion transport membrane layers, membrane units, membrane modules, and ion transport membrane assemblies (systems) are described in U.S. Pat. Nos. 5,681,373 and 7,179,323, both of which are wholly incorporated herein by reference.

With reference to the FIGURE, the apparatus comprises a plurality of ion transport membrane assemblies including a first ion transport membrane assembly 10 and a second ion transport membrane assembly 20. The first ion transport membrane assembly 10 has an inlet for introducing oxygen- and nitrogen-containing gas 5 into the first ion transport membrane assembly 10, a first outlet for withdrawing oxygen-depleted gas 13 from the first ion transport membrane assembly 10, and a second outlet for withdrawing an oxygen product gas 15 from the first ion transport membrane assembly 10.

The apparatus also comprises a turboexpander 40 having an inlet for introducing a turboexpander feed 85 into the turboexpander 40, the turboexpander feed 85 formed from a first portion of the oxygen-depleted gas 13, and an outlet for withdrawing an exhaust gas 45 from the turboexpander 40. The inlet of the turboexpander 40 is in downstream fluid flow communication with the first outlet of the first ion transport membrane assembly 10. A conduit is operatively disposed between the first ion transport membrane assembly 10 and turboexpander 40, to provide fluid flow communication between the devices. Heat may be recovered from the exhaust gas 45 from the turboexpander 40.

A turboexpander, also referred to as a turbo-expander, hot gas expander, or an expansion turbine, is any device through which a gas at a first, higher pressure is expanded to produce work and the gas at a second, lower pressure. The work produced by the turboexpander may be used to drive a compressor, an electric generator, or other suitable device known in the art.

The turboexpander feed is formed from a first portion of the oxygen-depleted gas 13 meaning that the first portion is used to form the turboexpander feed 85. The turboexpander feed may be a divided portion of the oxygen-depleted gas 13, where the turboexpander feed has the same composition as the oxygen-depleted gas withdrawn from the first ion transport membrane assembly 10.

The second ion transport membrane assembly 20 has an inlet for introducing a feed 19 into the second ion transport membrane assembly 20, the feed 19 formed from a second portion of the oxygen-depleted gas 13. The second ion transport membrane assembly 20 has a nitrogen product outlet for withdrawing nitrogen product gas 23, and another outlet for withdrawing oxygen product gas 25 from the second ion transport membrane assembly 20. The inlet of the second ion transport membrane assembly 20 is in downstream fluid flow communication with the first outlet of the first ion transport membrane assembly 10. A conduit is operatively disposed between the first ion transport membrane assembly 10 and the second ion transport membrane assembly 20, to provide fluid flow communication between the devices.

The feed 19 to the second ion transport membrane assembly 20 is formed from the second portion of the oxygen-depleted gas 13 meaning that the second portion is used to form the feed to the second ion transport membrane assembly 20. The feed 19 to the second ion transport membrane assembly 20 may be a divided portion of the oxygen-depleted gas 13, where the feed has the same composition as the oxygen-depleted gas withdrawn from the first ion transport membrane assembly 10.

As shown in the FIGURE, the feed to the turboexpander 40 and the feed to the second ion transport membrane assembly 20 are formed from separate portions of the oxygen-depleted gas 13. The second ion transport membrane assembly 20 is not in downstream fluid flow communication with the turboexpander 40 and the turboexpander 40 is not in downstream fluid flow communication with the second ion transport membrane assembly 20.

The apparatus may further comprise an optional oxygen compressor 100. The oxygen compressor 100 has an inlet and an outlet. The inlet of the oxygen compressor is in downstream fluid flow communication with at least one of the second outlet of the first ion transport membrane assembly 10 for receiving the oxygen product gas from the first ion transport membrane assembly 10, and the second outlet of the second ion transport membrane assembly 20 for receiving the oxygen product gas from the second ion transport membrane assembly 20. The oxygen compressor 100 may be in downstream fluid flow communication with both the second outlet of the first ion transport membrane assembly 10 and the second outlet of the second ion transport membrane assembly 20.

The FIGURE shows the embodiment where both the oxygen product gas from the first ion transport membrane assembly 10 and the oxygen product gas from the second ion transport membrane assembly 20 are passed to a common compressor 100. A conduit is operatively disposed in downstream fluid flow communication with the second outlet of the first ion transport membrane assembly 10 for receiving the oxygen product gas from the first ion transport membrane assembly 10. Another conduit is operatively disposed in downstream fluid flow communication with the second outlet of the second ion transport membrane assembly 20 for receiving the oxygen product gas from the second ion transport membrane assembly 20. Another conduit is operatively disposed in downstream fluid flow communication with both of the other conduits for receiving both the oxygen product gas from the first ion transport membrane assembly 10 and the oxygen product gas from the second ion transport membrane assembly 20. As shown in the FIGURE, the oxygen compressor 100 has an inlet in downstream fluid flow communication with the conduits for receiving the oxygen product gas from both the first ion transport membrane assembly and the second ion transport membrane assembly.

The apparatus may further comprise at least one flow control device 6, 8 adapted to control the flow rate of the turboexpander feed 85 to the turboexpander 40 and/or the flow rate of the feed to the second ion transport membrane assembly 20. One or more flow control devices may be installed in any suitable position in the apparatus to vary the split of the oxygen-depleted gas to the turboexpander 40 and the second ion transport membrane 20.

The apparatus may further comprise a gas turbine combustion engine 50 with a combustor having a combustion zone and a dilution zone. The combustion zone and/or the dilution zone may be in downstream fluid flow communication with the nitrogen product gas outlet of the second ion transport membrane assembly 20 for feeding the nitrogen product gas from the second ion transport membrane assembly 20 into the combustion zone and/or the dilution zone of the gas turbine combustion engine 50. The gas turbine combustion engine 50 may also have an inlet for introducing a fuel 51, an inlet for introducing an oxygen-containing gas 53, and an exhaust for discharging an exhaust gas 57. Gas turbine combustion engines are commercially available.

The process will be described with reference to the FIGURE.

The process comprises introducing an oxygen- and nitrogen-containing gas comprising oxygen and nitrogen and having a temperature ranging from 750° C. to 950° C. and a pressure ranging from 689 kPa (100 psia) to 4136 kPa (600 psia) into the first ion transport membrane assembly 10. An oxygen- and nitrogen-containing gas is defined as a gas that comprises at least oxygen and nitrogen and may contain other components, for example argon, carbon dioxide, carbon monoxide and/or water. Any oxygen- and nitrogen-containing gas known for use with ion transport membrane assemblies may be used. The oxygen- and nitrogen-containing gas may be, for example, air, oxygen-depleted air, or oxygen-enriched air. The oxygen- and nitrogen-containing gas may be exhaust from a combustor which is operated fuel lean (and therefore has oxygen in excess of that required to combust all the fuel).

The oxygen in the oxygen- and nitrogen-containing gas is transported through one or more membrane units to form an oxygen-depleted gas on the feed side of the one or more membrane units and an oxygen product gas on the product side of the one or more membrane units. The process comprises withdrawing an oxygen-depleted gas from the first ion transport membrane assembly, and withdrawing an oxygen product gas from the first ion transport membrane assembly 10 to provide a portion of the overall oxygen product. The process may be operated so that the oxygen-depleted gas is withdrawn at a pressure ranging from about 689 kPa (100 psia) to about than 4136 kPa (600 psia) and a temperature ranging from 750° C. to 950° C. The process may be operated so that the oxygen product gas is withdrawn at a pressure ranging from about 20 kPa (3 psia) to about 172 kPa (25 psia), prior to any recompression step to the final use pressure.

The process then comprises dividing the oxygen-depleted gas 13 into at least a first portion and a second portion. The oxygen-depleted gas 13 may be divided into additional portions if desired. The first portion may be a first divided portion. The second portion may be a second divided portion. The oxygen-depleted gas may be divided by any suitable device known in the art, for example a “T” junction, manifold, or the like. Alternatively, the oxygen-depleted gas may be divided by providing more than one outlet from the first ion transport membrane assembly 10.

The process comprises expanding turboexpander feed 85 in the turboexpander 40 to recover shaft work or electrical energy and to provide an exhaust stream 45 from the turboexpander 40. The turboexpander feed 85 is formed from the first portion of the oxygen-depleted gas 13.

The process further comprises introducing a feed 19 formed from the second portion of the oxygen-depleted gas 13 into the second ion transport membrane assembly 20. The feed formed from the second portion of the oxygen-depleted gas may have temperature ranging from 750° C. to 950° C. and a pressure ranging from about 689 kPa (100 psia) to about 4136 kPa (600 psia). Oxygen in the feed is transported through one or more membrane units in the second ion transport membrane assembly 20 to form a nitrogen-rich gas on the feed side of the one or more membrane units of the second ion transport membrane assembly 20 and a second oxygen product gas on the product side of the one or more membrane units of the second ion transport membrane assembly 20. The process comprises withdrawing the nitrogen product gas 23 having a pressure ranging from about 689 kPa (100 psia) to about 4136 kPa (600 psia) from the second ion transport membrane assembly 20 and withdrawing oxygen product gas 25 from the second outlet of the second ion transport membrane assembly 20.

The process may be operated, for example, such that the oxygen concentration in the nitrogen product gas is less than about 2 mole % oxygen. A nitrogen product gas with less than about 2 mole % oxygen may be suitable for use as a diluent to control NOx formation in a gas turbine, also called a combustion turbine, either by introduction of the nitrogen product gas directly into the gas turbine combustor or the gas turbine casing, or by introduction of the nitrogen product gas indirectly into the gas turbine combustor by first blending it with another stream such as a portion of the compressed air stream or with the fuel stream, and then introducing the blended stream into the gas turbine combustor.

Producing nitrogen with less than about 2 mole % oxygen may be facilitated by limiting the second portion of oxygen-depleted gas processed in the second ion transport membrane assembly 20 to only the amount required to produce the desired nitrogen product flow rate. This arrangement will require less membrane area than processing all of the original oxygen- and nitrogen-containing gas down to less than about 2 mole % oxygen.

From mass balances of the various species in the streams, the skilled person may determine flow rates and compositions of the various streams entering and leaving the first ion transport membrane assembly 10 and the second ion transport membrane assembly 20. The flow rate of the second portion of oxygen-depleted gas from the first ion transport membrane assembly to the second ion transport membrane assembly may be determined from this mass balance.

Once the flow rates and compositions of oxygen- and nitrogen-containing gas fed to each ion transport membrane assembly are known, as well as the individual oxygen product flow rates from each ion transport membrane assembly, one skilled in the art can determine the required membrane surface area, or required number of membrane units or modules. Models may be used to predict oxygen flux per unit area of membrane at a given set of process conditions. Suitable models are available in the literature.

In general, oxygen production from a membrane assembly can be increased by increasing the membrane surface area (e.g. adding membrane units) or increasing the oxygen flux through the membrane units in the assembly. The oxygen flux through the membranes in the first assembly may be increased by increasing the pressure of the oxygen- and nitrogen-containing feed gas, and/or decreasing the oxygen product pressure, and/or increasing the temperature of the membrane units in the assembly. Similarly, the pressures and/or temperatures may be regulated to increase or decrease the oxygen flux through the membrane units in the second ion transport membrane assembly as desired.

The process may further comprise selecting an operating pressure range for the oxygen- and nitrogen-containing gas, the oxygen product gas from the first ion transport membrane assembly, the oxygen product gas from the second ion transport membrane assembly, and the second portion of the oxygen-depleted gas. The process may also comprise selecting an operating temperature range of the first and second ion transport membrane assemblies. Each of the ion transport membrane assemblies comprise a number of membrane units, and a sufficient number of membrane units may be provided in each of the ion transport membrane assemblies to provide the nitrogen-rich gas with an oxygen concentration less than about 2 mole % oxygen for the selected pressure ranges and temperature ranges.

The second portion of the oxygen-depleted gas will have a molar flow rate and the operation of the process to provide less than about 2 mole % oxygen in the nitrogen product gas may depend on the molar flow rate of the second portion of the oxygen-depleted gas. Production of a nitrogen product gas with less than about 2 mole % oxygen will also depend on the number of membrane units (i.e. membrane surface area) in the first ion transport membrane assembly 10 and the number of membrane units in the second ion transport membrane assembly 20. The process may comprise providing a sufficient number of membrane units in each of the first ion transport membrane assembly and in the second ion transport membrane assembly to provide the nitrogen product gas with an oxygen concentration less than about 2 mole % oxygen. One skilled in the art can determine the number of membrane units sufficient or required to provide a nitrogen product gas with less than about 2 mole % oxygen without undue experimentation.

To provide nitrogen product gas with less than about 2 mole % oxygen for the molar flow rate of the second portion of the oxygen-depleted gas, the process may further comprise one or more of regulating or adjusting the pressure of the oxygen- and nitrogen-containing gas, regulating or adjusting the pressure of the oxygen product gas from the first ion transport membrane assembly 10, regulating or adjusting the pressure of the oxygen product gas from the second ion transport membrane assembly, regulating or adjusting the pressure of the second portion of the oxygen-depleted gas, regulating or adjusting a temperature in the first ion transport membrane assembly 10, and regulating or adjusting a temperature in the second ion transport membrane assembly 20.

Increasing the pressure of the oxygen- and nitrogen-containing gas increases the oxygen flux through the membranes in the first ion transport membrane assembly 10 and thereby decreases the oxygen concentration in the oxygen-depleted gas, which will in turn decrease the oxygen concentration in the nitrogen product gas 23. Decreasing the pressure of the oxygen- and nitrogen-containing gas decreases the oxygen flux through the membranes in the first ion transport membrane assembly 10 and thereby increases the oxygen concentration in the oxygen-depleted gas, which will in turn increase the oxygen concentration in the nitrogen product gas 23. The pressure of the oxygen- and nitrogen-containing gas may be increased or decreased by regulating or adjusting the discharge pressure of a supply compressor providing the inlet gas 5 to the system.

Decreasing the pressure of the oxygen product gas from the first ion transport membrane assembly 10 increases the oxygen flux through the membranes in the first ion transport membrane assembly 10 and thereby decreases the oxygen concentration in the oxygen-depleted gas, which will in turn decrease the oxygen concentration in the nitrogen product gas 23 (provided the flow is not changed by valve 6 or 8). Increasing the pressure of the oxygen product gas from the first ion transport membrane assembly decreases the oxygen flux through the membranes in the first ion transport membrane assembly and thereby increases the oxygen concentration in the oxygen-depleted gas, which will in turn increase the oxygen concentration in the nitrogen product gas 23. The pressure of the oxygen product gas from the first ion transport membrane assembly 10 may be increased or decreased by regulating or adjusting the suction pressure of oxygen compression equipment connected to the first ion transport membrane assembly 10, or by regulating or adjusting a backpressure control valve (not shown).

Decreasing the pressure of the oxygen product gas from the second ion transport membrane assembly 20 increases the oxygen flux through the membranes in the second ion transport membrane assembly 20 and thereby decreases the oxygen concentration in the nitrogen product gas. Increasing the pressure of the oxygen product gas from the second ion transport membrane assembly 20 decreases the oxygen flux through the membranes in the second ion transport membrane assembly and thereby increases the oxygen concentration in the nitrogen product gas 23. The pressure of the oxygen product gas from the second ion transport membrane assembly 20 may be increased or decreased by regulating or adjusting the suction pressure of oxygen compression equipment connected to the second ion transport membrane assembly, or by regulating or adjusting a backpressure control valve (not shown). The oxygen compression equipment for the second ion transport membrane assembly 20 may be shared with the first ion transport membrane assembly 10. Alternatively, the oxygen compression equipment for the second ion transport membrane assembly 20 may be separate from the oxygen compression equipment for the first ion transport membrane assembly 10.

Increasing the pressure of the second portion of the oxygen-depleted gas 13 increases the oxygen flux through the membranes in the second ion transport membrane assembly 20 and thereby decreases the oxygen concentration in the nitrogen product gas. Decreasing the pressure of the second portion of the oxygen-depleted gas 13 decreases the oxygen flux through the membranes in the second ion transport membrane assembly 20 and thereby increases the oxygen concentration in the nitrogen product gas 23. The pressure of the second portion of the oxygen-depleted gas may be increased by a compressor or decreased by a pressure control valve, but it is less practical than other options listed here to consider altering this pressure from whatever pressure exists exiting the first ion transport membrane assembly 10.

Increasing the temperature in the first ion transport membrane assembly 10 increases the oxygen flux through the membranes in the first ion transport membrane assembly 10 and thereby decreases the oxygen concentration in the oxygen-depleted gas, which will in turn decrease the oxygen concentration in the nitrogen product gas 23. Decreasing the temperature in the first ion transport membrane assembly 10 decreases the oxygen flux through the membranes in the first ion transport membrane assembly 10 and thereby increases the oxygen concentration in the oxygen-depleted gas 13, which will in turn increase the oxygen concentration in the nitrogen product gas 23. The temperature in the first ion transport membrane assembly 10 may be increased or decreased by regulating or adjusting the heat input to the oxygen- and nitrogen-containing gas 5 upstream of the first ion transport membrane assembly 10 (e.g., adjusting fuel input to a direct- or indirect-fired heater).

Increasing the temperature in the second ion transport membrane assembly 20 increases the oxygen flux through the membranes in the second ion transport membrane assembly 20 and thereby decreases the oxygen concentration in the nitrogen product gas 23. Decreasing the temperature in the second ion transport membrane assembly 20 decreases the oxygen flux through the membranes in the second ion transport membrane assembly 20 and thereby increases, the oxygen concentration in the nitrogen product gas. The temperature in the second ion transport membrane assembly 20 may be increased or decreased by regulating or adjusting the heat input to the second portion of oxygen-depleted gas 13 upstream of the second ion transport membrane assembly 20, but it is less practical than other options listed here to consider altering this temperature from whatever temperature exists exiting the first ion transport membrane assembly 10.

The pressure of the oxygen product gas from the first ion transport membrane assembly 10 may be regulated or adjusted to within about 20 kPa (3 psi) of the pressure of the oxygen product gas from the second ion transport membrane assembly 20, prior to any recompression step to the final use pressure. In this case, a shared oxygen cooling system and/or shared compression equipment can be used for the entire ion transport membrane system. Regulating or adjusting the pressures of the oxygen product gas from the first and second ion transport membrane assemblies to be about the same provides the benefit that a single compression train can be used for both assemblies.

As discussed above, since the nitrogen-rich gas may be withdrawn from the second ion transport membrane assembly 20 with less than about 2 mole % oxygen, the nitrogen product gas may be suitable for use as diluent to control NOx formation in a gas turbine. The process may further comprise introducing at least a portion of the nitrogen product as a low-oxygen content dilution gas 55 into a combustor of a gas turbine 50, also called a combustion turbine. The gas turbine combustor 50 may have a combustion zone and a dilution zone downstream of the combustion zone. The low-oxygen content dilution gas 55 may be introduced into the combustion zone and/or the dilution zone of the combustor. A portion of the low-oxygen content dilution gas 55 may be blended with the fuel. The low-oxygen content dilution gas may be introduced into the gas turbine at a pressure from 689 kPa (100 psia) to about 4136 kPa (600 psia). The nitrogen product withdrawn from the second ion transport membrane assembly may have sufficient pressure that it may be introduced into the gas turbine as the low-oxygen content dilution gas without further compression.

The desired nitrogen product flow rate may determine the split of the oxygen-depleted stream from the first ion transport membrane assembly 10 so that excess nitrogen product is not produced unnecessarily, thereby minimizing required membrane surface area originally installed into each of the ion transport membrane assemblies. The feed pressure of the oxygen- and nitrogen-containing gas to the first ion transport membrane assembly 10 may be regulated or adjusted so that the second ion transport membrane assembly 20 nitrogen product gas can be used in the gas turbine or other device without further compression.

The required membrane surface area of an ion transport membrane assembly is defined as the quantity of membranes, measured in square meters, for example, necessary to transport a desired flow rate of oxygen at a given set of process conditions on the feed and product sides (i.e. temperature, pressure, and oxygen concentration).

An exemplary embodiment of the present invention is illustrated in the schematic flow diagram of the FIGURE. A hot, pressurized, oxygen- and nitrogen-containing gas stream 5, typically air, is provided via a conduit from upstream compression and heating devices (not shown) at a typical pressure between 689 kPa (100 psia) and 4136 kPa (600 psia) and a typical temperature between 750° C. and 950° C. This feed gas is introduced into representative ion transport membrane assembly 10 shown as having membrane 11 dividing the assembly into feed side or zone 17 and product side or zone 18. This is a schematic representation to illustrate the process discussed here, and it is not meant to describe the structure of an actual ion transport membrane assembly as defined above.

High-purity oxygen product gas 15 typically containing greater than 99.0 mole oxygen is withdrawn via a conduit, and oxygen-depleted gas 13 typically containing 3 to 16 mole % oxygen is withdrawn via another conduit.

Oxygen-depleted gas 13 from the first ion transport membrane assembly 10 is divided into a first portion and a second portion, the amount of each divided portion controlled by the operation of flow control devices 6 and 8. The first portion is transported via a conduit to turboexpander 40, and the second portion is transported via another conduit to the second ion transport membrane assembly 20. Valves and orifices are examples of flow control devices. Alternatively, one of these flow control devices may be used to control the flow split and the other flow control device not used.

The first portion of the oxygen-depleted gas 13 is expanded in turboexpander 40 to recover shaft work or electrical energy, and a low-pressure (LP) nitrogen-rich exhaust 45 is withdrawn from the turboexpander 40 via a conduit.

The second portion of the oxygen-depleted gas 13 is introduced via a conduit into second ion transport membrane assembly 20 schematically shown as having membrane 21 dividing the assembly into feed side or zone 27 and product side or zone 28. Additional oxygen product gas 25 typically containing greater than 99.0 mole % oxygen is withdrawn via a conduit, and a nitrogen product gas 23 that is still further depleted in oxygen compared to the second portion of the oxygen-depleted gas 13 is withdrawn via a conduit typically containing, for example, 1.5 to 5 mole % oxygen. The nitrogen product gas may contain less than about 2 mole % oxygen.

The schematic diagrams of the first ion transport membrane assembly 10 and the second ion transport membrane assembly 20 each represent any assembly as defined above. An assembly may comprise one or more modules in series and/or parallel flow configuration. As stated above, exemplary ion transport membranes, membrane units, membrane modules, and membrane assemblies (systems) are described in U.S. Pat. Nos. 5,681,373 and 7,179,323, both of which are wholly incorporated herein by reference.

First-stage and second-stage ion transport membrane assemblies 10 and 20 may be designed and operated so that the pressures of the oxygen gas streams 15 and 25 are essentially equal, i.e., the absolute difference between the pressures of the streams from the two stages may be less than 20 kPa (3 psi). This configuration is shown schematically in the FIGURE wherein the oxygen gas streams 15 and 25 are optionally combined in and optionally compressed in optional product oxygen compressor 100 to provide compressed oxygen product. The oxygen gas streams 15 and 25 may require cooling (not shown) prior to compression. The cooling may occur before or after the streams are combined.

The high pressure (HP) nitrogen product gas 23 may be utilized as a diluent or dilution gas to control nitrogen oxide (NOx) formation in gas turbine 50. The combustor of a typical gas turbine system may comprise a combustion zone and a dilution zone, and the combustion zone may have primary and secondary combustion regions. The combustion zone and dilution zone may be disposed in a liner that in turn is disposed in an outer shell of the combustor system. The term “diluent” as used herein means a gas with a lower oxygen concentration than the oxidant gas that is combusted with fuel in the combustion zone of the gas turbine system. The nitrogen product gas withdrawn, or any portion of gas derived therefrom, may be introduced at any desired location in the gas turbine combustor to control the formation of nitrogen oxide (NOx) in the gas turbine 50. The nitrogen product gas may be preferably produced at a pressure between 1724 kPa (250 psia) and 3103 kPa (450 psia).

In an embodiment for the utilization of the nitrogen product gas 23, the ion transport membrane assemblies may be designed and operated so that the oxygen content of the nitrogen product gas is less than about 2 mole %. This may be effected by selecting design and operating features such as the total membrane surface area resulting from the number of membrane units used in each of ion transport membrane assemblies 10 and 20, the flow ratio of the first and second portions of the oxygen-depleted gas 13, and the operating feed and/or oxygen product pressure and/or temperature of the assemblies.

The fraction of oxygen-depleted gas from first ion transport membrane assembly 10 sent to expander 40 in the embodiments of the FIGURE may be chosen so that the nitrogen content of the oxygen-depleted fraction sent to second ion transport membrane assembly 20 matches the desired nitrogen product flow rate. In other words, the desired nitrogen production rate would determine the split of first portion of oxygen-depleted portion so that excess nitrogen is not produced unnecessarily, thereby minimizing required membrane surface area. Finally, the air feed pressure of the oxygen containing gas 5 to first ion transport membrane assembly 10 may be chosen so that the nitrogen product from second ion transport membrane assembly 20 can be used at pressure without further compression. For example, the diluent pressure specification for a GE 7FB gas turbine is approximately 2.7 MPa (400 psia). When the pressure drops for the various required unit operations are considered, a desired air feed pressure to first ion transport membrane assembly 10 would be about 3.0 MPa (430 psia). This pressure would provide sufficient driving force to achieve the necessary oxygen transport rate that would yield the desired oxygen content of the nitrogen product, i.e., less than about 2 mole %, at reasonable oxygen product pressure and membrane area requirement.

We claim:

1. An apparatus for producing co-product oxygen and nitrogen streams, the apparatus comprising:
a first, ion transport membrane assembly having an inlet for introducing an oxygen- and nitrogen-containing gas comprising oxygen and nitrogen into the first ion transport membrane assembly, a first outlet for withdrawing an oxygen-depleted gas from the first ion transport membrane assembly, and a second outlet for withdrawing an oxygen product gas from the first ion transport membrane assembly;
a turboexpander having an inlet for introducing a turboexpander feed into the turboexpander, the turboexpander feed formed from a first portion of the oxygen-depleted gas, and an outlet for withdrawing an exhaust gas from the turboexpander, the inlet of the turboexpander in downstream fluid flow communication with the first outlet of the first ion transport membrane assembly; and
a second ion transport membrane assembly having an inlet for introducing a feed into the second ion transport membrane assembly, the feed formed from a second portion of the oxygen-depleted gas, a first outlet for withdrawing a nitrogen product gas, and a second outlet for withdrawing an oxygen product gas from the second ion transport membrane assembly, the inlet of the second ion transport membrane assembly in downstream fluid flow communication with the first outlet of the first ion transport membrane assembly;
wherein the second ion transport membrane assembly is not in downstream fluid flow communication with the turboexpander, and
wherein the turboexpander is not in downstream fluid flow communication with the second ion transport membrane assembly.

2. The apparatus of claim 1 further comprising:
an oxygen compressor having an inlet and an outlet, the inlet of the oxygen compressor in downstream fluid flow communication with at least one of the second outlet of the first ion transport membrane assembly for receiving the oxygen product gas from the first ion transport membrane assembly, and the second outlet of the second ion transport membrane assembly for receiving the oxygen product gas from the second ion transport membrane assembly.

3. The apparatus of claim 1 further comprising:
an oxygen compressor having an inlet and an outlet, the inlet of the oxygen compressor in downstream fluid flow communication with the second outlet of the first ion transport membrane assembly for receiving the oxygen product gas from the first ion transport membrane assembly, and the second outlet of the second ion transport membrane assembly for receiving the oxygen product gas from the second ion transport membrane assembly.

4. The apparatus of claim 1 further comprising at least one flow control device adapted to control the flow rate of the turboexpander feed to the turboexpander and/or the flow rate of the feed to the second ion transport membrane assembly.

5. The apparatus of claim 1 further comprising a gas turbine combustion engine with a combustor having a combustion zone and a dilution zone, the gas turbine combustion engine having an inlet for introducing a low-oxygen content dilution gas, the low-oxygen content dilution gas formed from the nitrogen product gas, an inlet for introducing a fuel, and an inlet for introducing an oxygen-containing gas, the combustion zone and/or the dilution zone in downstream fluid flow communication with the first outlet of the second ion transport membrane assembly for receiving the low-oxygen content dilution gas formed from the nitrogen product gas.

6. A process for producing co-product oxygen and nitrogen streams, the process comprising:
providing the apparatus of claim 1;
introducing the oxygen- and nitrogen-containing gas comprising oxygen and nitrogen into the inlet of the first ion transport membrane assembly, the oxygen- and nitrogen-containing gas having a temperature ranging from 750° C. to 950° C. and a pressure ranging from 689 kPa to 4136 kPa, withdrawing the oxygen-depleted gas from the first outlet of the first ion transport membrane assembly, and withdrawing the first oxygen product gas from the second outlet of the first ion transport membrane assembly;
dividing the oxygen-depleted gas into the first portion and the second portion;
expanding the turboexpander feed formed from the first portion of the oxygen-depleted gas in the turboexpander to recover shaft work or electrical energy and to provide the exhaust gas from the turboexpander; and
introducing the feed formed from the second portion of the oxygen-depleted gas into the inlet of the second ion transport membrane assembly, withdrawing the nitrogen product gas having a pressure ranging from 689 kPa to 4136 kPa from the second ion transport membrane assembly, and withdrawing the oxygen product gas from the second outlet of the second ion transport membrane assembly.

7. A process for producing co-product oxygen and nitrogen streams using the apparatus of claim 1, the process comprising:
introducing the oxygen- and nitrogen-containing gas comprising oxygen and nitrogen into the inlet of the first ion transport membrane assembly, the oxygen- and nitrogen-containing gas having a temperature ranging from 750° C. to 950° C. and a pressure ranging from 689 kPa to 4136 kPa, withdrawing the oxygen-depleted gas from the first outlet of the first ion transport membrane assembly, and withdrawing the oxygen product gas from the second outlet of the first ion transport membrane assembly;
dividing the oxygen-depleted gas into the first portion and the second portion;
expanding the turboexpander feed formed from the first portion of the oxygen-depleted gas in the turboexpander to recover shaft work or electrical energy and to provide the exhaust gas from the turboexpander; and
introducing the feed formed from the second portion of the oxygen-depleted gas into the inlet of the second ion transport membrane assembly, withdrawing the nitrogen product gas having a pressure ranging from 689 kPa to 4136 kPa from the second ion transport membrane assembly, and withdrawing the oxygen product gas from the second outlet of the second ion transport membrane assembly.

8. The process of claim 7 wherein the pressure of the oxygen product gas from the first ion transport membrane assembly is regulated to within 20 kPa of the pressure of the oxygen product gas from the second ion transport membrane assembly.

9. The process of claim 7 further comprising:
selecting an operating pressure range for the oxygen- and nitrogen-containing gas;
selecting an operating pressure range for the oxygen product gas from the first ion transport membrane assembly;
selecting an operating pressure range for the oxygen product gas from the second ion transport membrane assembly;
selecting an operating pressure range for the feed to the second ion transport membrane assembly;
selecting an operating temperature range for the first ion transport membrane assembly; and
selecting an operating temperature range for the second ion transport membrane assembly;
wherein the first ion transport membrane assembly comprises a first number of membrane units and the second ion transport membrane assembly comprises a second number of membrane units and wherein the first number of membrane units and the second number of membrane units are each provided in a number sufficient to provide the nitrogen product gas with an oxygen concentration less than about 2 mole % oxygen for the selected operating pressure range for the oxygen- and nitrogen-containing gas, the selected operating pressure range for the oxygen product gas from the first ion transport membrane assembly, the selected operating pressure range for the oxygen product gas from the second ion transport membrane assembly, the selected operating pressure range for the feed to the second ion transport membrane assembly, the selected operating temperature range for the first ion transport membrane assembly, and the operating temperature range for the second ion transport membrane assembly.

10. The process of claim 7 wherein the feed to the second ion transport membrane assembly has a molar flow rate, and wherein the first ion transport membrane assembly comprises a first number of membrane units and the second ion transport membrane assembly comprises a second number of membrane units wherein the first number of membrane units and the second number of membrane units are sufficient to provide the nitrogen product gas with an oxygen concentration less than about 2 mole % oxygen, the process further comprising:
regulating the pressure of the oxygen- and nitrogen-containing gas;
regulating a pressure of the oxygen product gas from the first ion transport membrane assembly;
regulating a pressure of the second oxygen product gas from the second ion transport membrane assembly;
regulating a pressure of the feed to the second ion transport membrane assembly;
regulating a temperature in the first ion transport membrane assembly; and
regulating a temperature in the second ion transport membrane assembly;
wherein the pressure of the oxygen- and nitrogen-containing gas, the pressure of the oxygen product gas from the first ion transport membrane assembly, the pressure of the oxygen product gas from the second ion transport membrane assembly, the pressure of the feed to the second ion transport membrane assembly, the temperature in the first ion transport membrane assembly, and the temperature in the second ion transport membrane assembly are regulated to provide the nitrogen product gas with an oxygen concentration less than about 2 mole % oxygen for the molar flow rate of the feed to the second ion transport membrane assembly.

11. The process of claim 7 further comprising introducing a low-oxygen content dilution gas into a combustor of a gas turbine, the low-oxygen content dilution gas formed from the nitrogen product gas.
